(19) United States
(12) Patent Application Publication
(10) Pub. No.: US 2013/0292341 A1
(43) Pub. Date: Nov. 7, 2013

(54) SYSTEM AND METHOD FOR SEPARATING LIQUID MIXTURES

(71) Applicants: Steven Richardson, Thatcher, AZ (US); Jason M. Morgan, Morenci, AZ (US)

(72) Inventors: Steven Richardson, Thatcher, AZ (US); Jason M. Morgan, Morenci, AZ (US)

(73) Assignee: FREEPORT-MCMORAN CORPORATION, Phoenix, AZ (US)

(21) Appl. No.: 13/465,751

(22) Filed: May 7, 2012

(51) Int. Cl. B01D 17/032; B01D 17/04

(52) U.S. Cl. 210/708; 210/513; 210/519

(57) ABSTRACT

The present invention provides a method and system for separating phases of a liquid mixture or dispersion from each other. The system includes a settler system, which includes a coalescing-enhancing plate comprising a front face and rear face and a plurality of openings. The openings are configured to selectively manipulate the flux of portions of the mixture to thereby increase phase separation of the mixture.

### FIELD OF INVENTION

The invention generally relates to systems and methods for separating components of a mixture of liquids. More particularly, the invention relates to systems and methods for separating liquid phases of a dispersion of two or more immiscible liquids.

### BACKGROUND OF THE INVENTION

Liquid-liquid separation systems are frequently used to mix and then separate mixtures of liquids. For example, mixer-settlers are used to separate liquid components of a mixture by density. Typically, mixer-settlers include a mixer section, which mixes two or more immiscible liquids to form a dispersion. The dispersion then progresses to a settler section, where the two liquid components settle into separate phases, which are selectively removed from the mixer-settler.

Mixer-settlers are commonly used in hydrometallurgical processes. For example, mixer-settlers may be used in solution extraction and/or stripping processes to recover metal values from pregnant leach solutions created by leaching processes. During solution extraction, an aqueous pregnant leach solution and an organic liquid, including an extractant, are mixed together in the mixer section of the mixer-settler to form a dispersion of the aqueous and organic liquids. This dispersion is forwarded to the settler section of the mixer-settler, which separates the metal value-containing organic solution, also known as a loaded organic solution, from the aqueous solution. The loaded organic solution can then be stripped, e.g., using another mixer-settler or other system, to create a stripped organic phase and an aqueous phase including the desired metal values.

In an exemplary hydrometallurgical process for extracting metal, such as, for example, copper, copper ore material is leached using an aqueous leach solution to create a pregnant leach solution containing copper ions. The pregnant leach solution is forwarded to a mixer section of a mixer-settler of a solution extraction system. A suitable organic extractant solution, such as, for example Alamine 336, aldoxime, an aldoxime/ketoxime blend, or a modified aldoxime/ketoxime blend, is mixed with the pregnant leach solution in the mixer section of the mixer-settler, creating a dispersion. The dispersion is then forwarded to the settler section of the mixer-settler, where the liquids are separated into a loaded organic solution including copper and a relatively barren aqueous solution. The loaded organic solution may be forwarded to a stripping system, which may include one or more additional mixer-settlers, to remove the metal values from the organic solution and form a depleted organic phase and a loaded aqueous phase.

Conventional mixer-settlers face a number of difficulties in effectively separating the two liquids of the dispersion. For example, species may become entrained in the phase from which they are to be separated, causing each phase to contain an undesirable amount of the other phase. Accordingly, systems and methods to improve phase separation of a mixer settler are desired.

### SUMMARY OF THE INVENTION

The present disclosure provides an improved system and method for the separation of multiple liquid phases from a dispersion. As set forth in more detail below, the improved system and method use a coalescing-enhancing plate in a settling apparatus (e.g., a settler portion of a mixer-settler) to selectively manipulate (e.g., increase) flux or linear flow rates of various components of the mixture and thereby increase separation of the liquid phases. It is believed that the selective increase in flux increases bombardment of entrained material, which, in turn, increases coalescence of the phases and reduces entrainment of unwanted species in the respective phases.

In accordance with various embodiments of the disclosure, a coalescing-enhancing plate in accordance with the present disclosure comprises a plate with a front face and rear face having at least one group of openings which extend from the front face through the rear face and are configured to cause an increase in the flow rate or flux of one or more portions of a liquid mixture and/or a partially-separated dispersion. In accordance with various aspects of these embodiments, one or more groups of openings are arranged in one or more horizontal rows, wherein each row corresponds to a portion, e.g., organic, aqueous, and/or interface portion, of a partially-separated dispersion.

In accordance with additional embodiments of the present disclosure, a mixer-settler comprises a first vessel to mix two or more liquid solutions to form a dispersion and a second vessel configured to conduct the flow of a liquid mixture and/or dispersion to cause the mixture to separate into two or more phases. The second vessel comprises an inbound portion, an outbound portion, and a coalescing-enhancing plate having a front face and a rear face and at least one group of openings configured to cause an increase in the flow rate or flux of one or more portions of a partially-separated mixture to cause further separation of the phases of the partially-separated mixture. In various aspects, the coalescing-enhancing plate is substantially vertical and substantially perpendicular to the flow of the dispersion. In further aspects, the coalescing-enhancing plate is located in or near the output section of a mixer-settler assembly.

In accordance with yet additional embodiments of the present disclosure, the method comprises introducing a liquid mixture and/or dispersion into an inbound portion of a vessel comprising the inbound portion and an outbound portion, partially separating the dispersion to form a partially-separated mixture, and selectively manipulating the flow pattern and flux of selected portions of the partially-separated mixture and/or dispersion by passing the partially-separated mixture through a coalescing-enhancing plate having a front face and a rear face and at least one group of openings configured to cause an increase in the flow rate or flux of the separated portions of the partially-separated mixture and/or dispersion to cause further separation of the phases of the mixture.

### BRIEF DESCRIPTION OF THE DRAWING FIGURES

The drawing figures described herein are for illustration purposes only and are not intended to limit the scope of the present disclosure in any way. The present disclosure will become more fully understood from the detailed description and the accompanying drawing figures herein, wherein;

FIG. 1 illustrates an exemplary hydrometallurgical metal recovery process in accordance with the present disclosure;

FIGS. 2A and 2B illustrate a top view and a side view, respectively, of an exemplary settler system in accordance with the present disclosure;

FIG. 3 illustrates a front view of an exemplary coalescing-enhancing plate in accordance with the present disclosure;

FIGS. 4A-4C illustrate side views of exemplary coalescing-enhancing plates in accordance with the present disclosure; and

FIG. 5 illustrates organic liquid entrainment in aqueous liquid values obtained before and after installation of an exemplary coalescing-enhancing member in accordance with exemplary embodiments of the present disclosure.

It will be appreciated that elements in the figures are illustrated for simplicity and clarity and have not necessarily been drawn to scale. For example, the dimensions of some of the elements in the figures may be exaggerated relative to other elements to help to improve understanding of illustrated embodiments of the present disclosure.

### DETAILED DESCRIPTION

The detailed description of various embodiments herein makes reference to the accompanying drawing figures, which show various embodiments and implementations thereof by way of illustration and best mode, and not of limitation. While these embodiments are described in sufficient detail to enable those skilled in the art to practice the embodiments, it should be understood that other embodiments may be realized and that mechanical and other changes may be made without departing from the spirit and scope of the present disclosure.

Also, any reference to attached, fixed, connected or the like may include permanent, removable, temporary, partial, full and/or any other possible attachment option. Additionally, though the various embodiments discussed herein may be carried out in the context of metal recovery, it should be understood that systems and methods disclosed herein may be incorporated into other systems to separate components of a dispersion in accordance with the present disclosure.

The various embodiments of a liquid separation system, including a coalescing-enhancing plate, and method employing the plate, comprise the features hereinafter described and particularly pointed out in the claims. The following description and the annexed drawing figures set forth in detail and demonstrate certain illustrative embodiments of the disclosure. However, these embodiments are indicative of but a few of the various ways in which the principles disclosed herein may be employed. Other objects, advantages and novel features will become apparent from the following detailed description when considered in conjunction with the figures.

Systems and methods in accordance with the present disclosure provide the ability to manipulate the flow patterns of a dispersion, partially-separated liquid mixture, or partially-separated dispersion, to increase separation of one or more phases of the mixture or dispersion. For example, use of a coalescing-enhancing plate of the present disclosure may provide for selectively allowing certain portions of the mixture or dispersion to pass through openings in the plate to selectively manipulate the flow rate or flux of components of the mixture based on the locations, sizes, and/or geometric configuration of openings in the plate. As set forth in more detail below, the coalescing-enhancing plate may be included in a settler section of a mixer-settler. In this case, the plate may be a part of a series of internals or fences used to separate phases of a liquid dispersion.

In various exemplary embodiments, the plate is the last internal or fence in the system. The plate can be configured to target droplets, created during mixing, with low enough mass and specific phase velocity that the droplets continue to be suspended in an opposing phase instead of rising or falling to the interface between the immiscible phases, and increase coalescence of the droplets and thereby increase separation of the respective phases.

An exemplary coalescing-enhancing plate can include such openings at particular elevations which are calculated based on the components of partially-separated phases of a dispersion and dimensions and properties of the system, such as an organic to aqueous ratio of the dispersion, flow rates of the dispersion and separated phases, dimensions of the settler, and the like. In such embodiments, the particular elevations of the openings may correspond to desired components of the dispersion, such that each elevation corresponds with and affects the flow of a particular component.

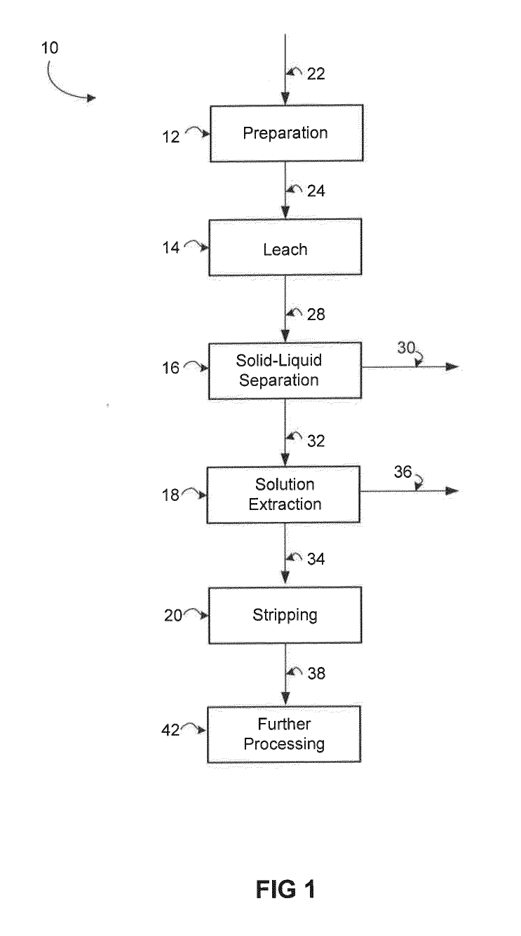

To assist in understanding the context of the present disclosure, an exemplary hydrometallurgical metal recovery process configured to utilize systems and methods to separate dispersions in accordance with the present disclosure is illustrated in FIG. 1. In the exemplary process, metal-bearing material 22 is subjected to hydrometallurgical metal recovery process 10 to recover metal value contained in an ore. Metal-bearing material 22 can include chalcopyrite (CuFeS₂), chalcocite (Cu₂S), bornite (CusFeS₄), and covellite (CuS), malachite (Cu₂CO₃(OH)₂), pseudomalachite (Cu₅[(OH)₂PO₄]₂), azurite (Cu₃(CO₃)₂(OH)₂), chrysocolla ((Cu,Al)₂H₂Si₂O₅(OH)₄.nH₂0), cuprite (Cu₂O), brochanite (CuSO₄.3Cu(OH)₂), atacamite (Cu₂[OH₃Cl]) and other copper-bearing minerals. Metal-bearing material 22 can comprise any metal suitable for extraction via solution extraction.

Metal-bearing material 22 is processed in a preparation step 12, creating prepared metal-bearing material 24. Prepared metal-bearing material 24 is forwarded to a leach step 14. Leach step 14 produces a metal-bearing slurry 28, which is forwarded to a solid-liquid separation step 16. Leach step 14 can comprise a pressure leach, heap leach, and/or agitation process. Solid-liquid step 16 produces a solid residue 30 and a metal-bearing solution 32. Metal-bearing solution 32 is then subjected to a solution extraction step 18. During solution extraction step 18, an organic extractant solution is mixed with metal-bearing solution 32 to produce a loaded organic stream 34 and a barren organic stream 36. Loaded organic stream 34 is then stripped in stripping step 20 to produce a separated metal-bearing solution 38 and a barren organic stream 36. In various embodiments, separated metal-bearing solution 38 comprises a rich electrolyte. Separated metal-bearing solution 38 can then be subjected to a further processing step 42, such as, for example, electrowinning.

In accordance with various embodiments, solution extraction step 18 and/or stripping step 20 employ a mixer-settler in accordance with various embodiments of the present disclosure. Although either step may employ a mixer-settler as set forth herein, an exemplary process is described herein with reference to step 18 including a mixer-settler, including a coalescing-enhancing plate as described herein. The mixer-settler includes one or more mixer sections to mix a metal-bearing solution with an organic extractant solution to form a dispersion, and a settler section.

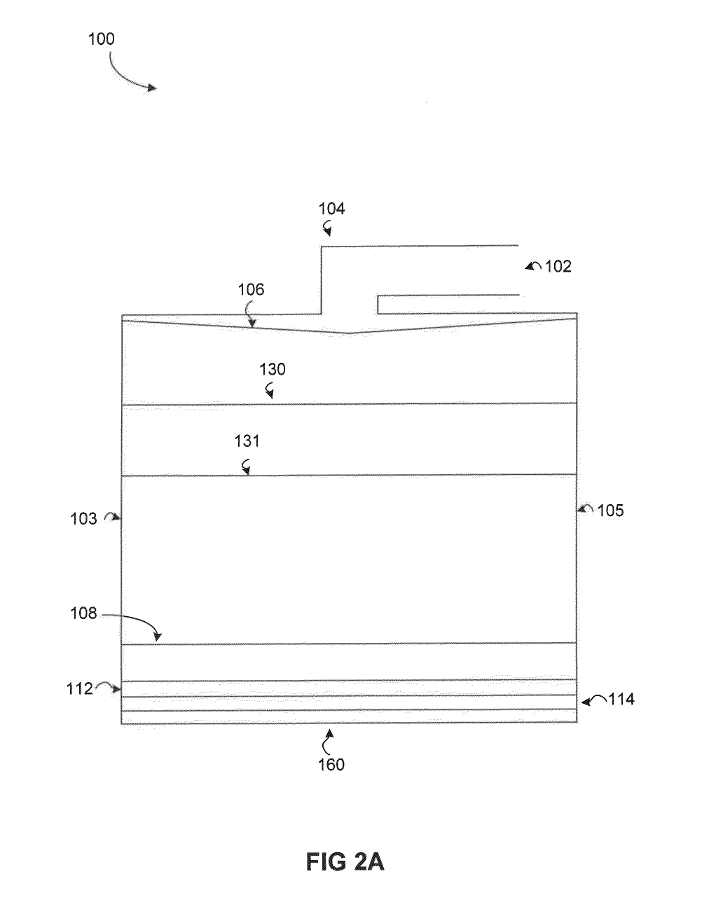

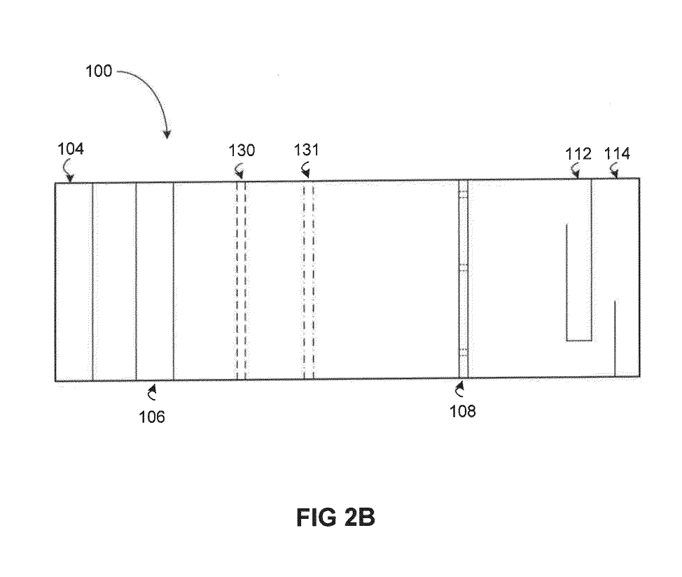

With initial reference to FIGS. 2A and 2B, an exemplary settler section 100 of a mixer-settler (e.g., for extraction step 18) is illustrated. Settler section 100 includes a settler section feed section 104, perimeter walls 103 and 105, and a discharge section 160.

During settler section operation, a feed 102 enters settler section 100 at feed section 104, and separated liquid solutions exit discharge section 160. In an exemplary embodiment, feed 102 comprises a mixture of metal-bearing solution 32 from hydrometallurgical metal recovery process 10 and an organic extractant solution. However, feed 102 can be any mixture containing at least two immiscible and separable liquids, including a dispersion and/or emulsion of the liquids.

In various exemplary embodiments, perimeter walls 103 and 105 form the sides of the mixer-settler and act to contain the feed 102 within settler section 100. For example, perimeter walls 103 and 105 may be substantially parallel, forming a substantially rectangular settler section 100. In other embodiments, perimeter walls 103 and 105 may be angled with respect to each other, tapering towards each other near the discharge section 160. In yet other embodiments, perimeter walls 103 and 105 may taper away from each other near the discharge section 160. Any configuration of perimeter walls 103 and 105 which suitably contains feed 102 within settler section 100 is within the scope of the present disclosure.

In accordance with an exemplary embodiment, and with continued reference to FIGS. 2A and 2B, settler section 100 further comprises a primary flow distributor 106. Settler section 100 can further comprise a secondary flow distributor 130 and a tertiary flow distributor 131. Although FIG. 2 illustrates a primary and two additional flow distributors, the use of any number of flow distributors is in accordance with the present disclosure.

In various exemplary embodiments, settler section 100 comprises a coalescing-enhancing plate 108. In various exemplary aspects, coalescing-enhancing plate 108 is located near discharge section 160 of settler section 100. In various exemplary embodiments, coalescing-enhancing plate 108 is located downstream from secondary flow distributor 130. In other embodiments, coalescing-enhancing plate 108 is located downstream from tertiary flow distributor 131, and in accordance with yet additional exemplary embodiments, plate 108 is located downstream from the furthest downstream flow distributor. Further, as illustrated, plate 108 is substantially upstream from one or more weirs 112, 114.

In various exemplary embodiments, coalescing-enhancing plate 108 is substantially vertical within settler section 100. In other exemplary embodiments, coalescing-enhancing plate 108 is oriented at an angle less than 90° relative to the bottom of settler section 100. In yet other exemplary embodiments, coalescing-enhancing plate 108 is oriented at an angle greater than 90° relative to the bottom of settler section 100. Any orientation of coalescing-enhancing plate 108 which reduces entrainment of undesired species in the phases of a liquid mixture is within the scope of the present disclosure.

In various exemplary embodiments, coalescing-enhancing plate 108 is substantially the same width as settler section 100, such that nearly all of the liquid mixture flowing through settler section 100 flows through coalescing-enhancing plate 108. In other exemplary embodiments, coalescing-enhancing plate 108 is less wide than the width of the settler section 100. Any width of coalescing-enhancing plate 108 which reduces entrainment of undesired species in the respective phases is within the scope of the present disclosure.

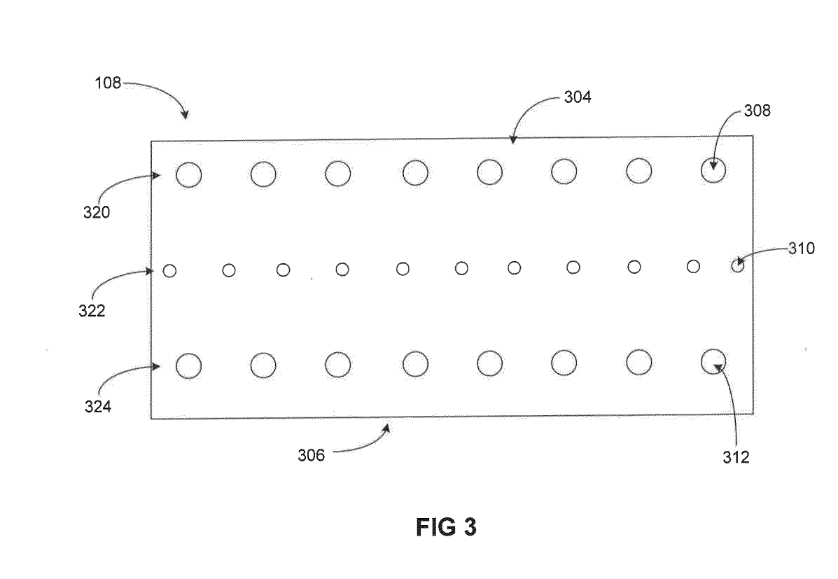

With reference to FIG. 3, exemplary coalescing-enhancing plate 108 comprises a front face 304 and a rear face 306. In various exemplary embodiments, coalescing-enhancing plate 108 is configured such that front face 304 is substantially perpendicular to the flow of the dispersion through settler section 100. In other exemplary embodiments, coalescing-enhancing plate 108 can be configured such that front face 304 is at an obtuse angle relative to perimeter wall 103. In yet other exemplary embodiments, coalescing-enhancing plate 108 can be configured such that front face 304 is at an acute angle relative to the perimeter wall 103. Any position of front face 304 relative to perimeter wall 103 is within the scope of the present disclosure.

In various exemplary embodiments, coalescing-enhancing plate 108 is configured such that rear face 306 is substantially parallel to front face 304. In other exemplary embodiments, coalescing front face 304 and rear face 306 may be oriented at an angle to each other. Stated another way, thickness of coalescing-enhancing plate 108 may vary along its width, such that front face 304 and rear face 306 are not substantially parallel. Any orientation of front face 304 and rear face 306 relative to each other is within the scope of the present disclosure.

In various exemplary embodiments, coalescing-enhancing plate 108 comprises at least one group of openings. With continued reference to FIG. 3, coalescing-enhancing plate 108 may comprise openings 308. Openings 308 may improve coalescence and reduce entrainment in settler section 100, by, for example, causing a pressure drop against the coalescing-enhancing plate 108, which forces the liquid to pass through openings 308 at a greater velocity. Increasing the flux of the liquid also increases the flow rate of droplets which are suspended in the opposing phase. Increasing the flow rate of these droplets may increase the number of liquid-liquid collisions, improving coalescence and reducing entrainment of the droplets. Further, coalescing-enhancing plate 108 and openings 308 can influence the flow pattern of the dispersion or partially-separated dispersion upstream and downstream of the coalescing-enhancing plate 108, including inducing a circulating flow pattern in the down-stream flow. Such a circulating flow pattern can influence how the dispersion and/or mixture interacts with down-stream obstruction or element and is thought to increase coalescence of the respective phases.

For example, re-entrainment of components of the partially-separated dispersion can occur in discharge section 160 of settler section 100. Creating a circulating flow pattern can reduce such re-entrainment between coalescing-enhancing plate 108 and weirs 112 and/or 114 by, for example, increasing the flowrate of individual components near the bottom and top of the vessel and/or decreasing the flowrate of the components at or near their interface.

In various exemplary embodiments, openings 308 comprise a group of openings of the same size and shape as each other. For example, in various exemplary embodiments, openings 308 comprise openings which are substantially circular and have the same diameter. In other embodiments, openings 308 can comprise openings of different diameter. Any configuration of openings 308 which improves phase separation in settler section 100 is within the scope of the present disclosure.

In various exemplary embodiments, coalescing-enhancing plate 108 includes a second group of openings 310. Second group openings 310 may comprise a different size and/or shape than openings 308. In other exemplary embodiments, second group openings 310 can comprise the same size and shape as openings 308. Second group openings 310 may be located at a different horizontal position of coalescing-enhancing plate 108 than openings 308.

For example, in various exemplary embodiments, openings 308 are located along a horizontal row 320. In such embodiments, coalescing-enhancing plate 108 may comprise second group openings 310 located along a second horizontal row 322. In various exemplary embodiments, coalescing-enhancing plate 108 may further comprise a third group of openings 312 located along a third horizontal row 324. Any number of openings, located along any number of horizontal rows, is within the scope of the present disclosure.

In various exemplary embodiments, horizontal rows 320, 322, and 324 can be located at heights along coalescing-enhancing plate 108 which correspond to characteristics of the phases of the dispersion. For example, in such embodiments, second horizontal row 322 can be located at or near the interface between two liquid phases. First horizontal row 320 can be positioned at a point within the less dense phase of the partially-separated dispersion which corresponds to a relatively significant concentration of entrainment of the denser phase. Third horizontal row 324 can be positioned at a point within the denser phase of the partially-separated dispersion which corresponds to a significant concentration of entrainment of the less dense phase. Any location of horizontal rows 320-324 which improves phase separation in settler section 100 is within the scope of the present disclosure.

In various exemplary embodiments, the size and shape of openings 308-312 correspond to the position of the openings on coalescing-enhancing plate 108. In general, as the size of an opening decreases, the average velocity of liquid passing through the hole would increase. As a result, a hole of a smaller diameter will generally impart a greater increase in average velocity of the liquid than a hole of a larger diameter.

In relation to the present disclosure, the increase in flux of components of the partially-separated dispersion is inversely proportional to the diameter of openings 308-312. Therefore, a smaller diameter hole can be used to impart a greater increase in flux, and a larger hole can be used to impart a lesser increase in flux. As a result, openings 308-312 can be sized to provide a desired increase in flux of the partially-separated dispersion. Any size diameter of openings 308-312 which improves the phase separation in settler section 100 is within the scope of the present disclosure.

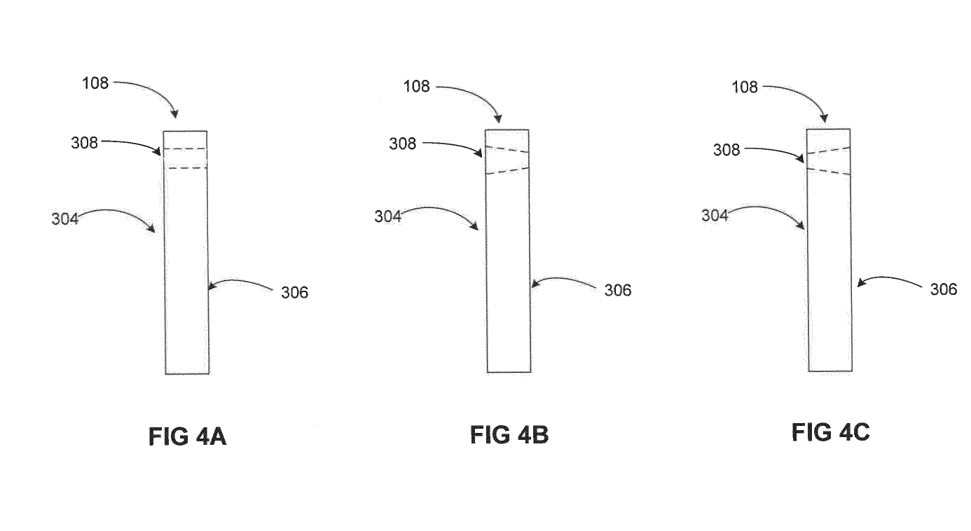

For example, openings 308-312 can comprise cylindrical-shaped openings. In such embodiments, the diameter of openings 308-312 is substantially the same on the front face 304 and rear face 306 of coalescing-enhancing plate 108. For example, with initial reference to FIG. 4A, an exemplary opening 308 has a constant diameter from front face 304 through to rear face 306, forming a cylindrical-shaped hole.

In various embodiments, openings 308-312 can comprise conical or frusto-conical shaped openings. In such configurations, the diameter of openings 308-312 is the different on the front face 304 and rear face 306 of coalescing-enhancing plate 108. For example, with reference to FIG. 4B, openings 308 may have a larger diameter on front face 304 than on rear face 306, giving openings 308 a conical shape which tapers from larger to smaller in the direction of the flow of the dispersion. With reference to FIG. 4C, in other exemplary embodiments, openings 308 can have a smaller diameter on front face 304 than on rear face 306, giving openings 308 a conical shape which tapers from smaller to larger in the direction of the flow of the dispersion. Any shape of openings 308-312, including cylindrical, conical, and/or hourglass-shaped, which allows the dispersion to flow through coalescing-enhancing plate 108 is within the scope of the present disclosure. Further, a coalescing plate can have rows of openings of various sizes and shapes, including those previously described, and any such configurations are within the scope of the present disclosure.

In addition to openings 308-312, an exemplary coalescing-enhancing plate 108 in accordance with the present disclosure can comprise a void section. For example, coalescing-enhancing plate 108 may comprise a void section or opening at or near the bottom of settler section 100, such that a denser phase of a liquid mixture or dispersion may pass through coalescing-enhancing plate 108 through the opening. In other embodiments, coalescing-enhancing plate 108 may comprise a void section near the top of settler section 100, such that a less dense phase of a liquid mixture or dispersion may pass through the opening of coalescing-enhancing plate 108. Such void sections may be combined with any number, type, or arrangement of openings 308-312.

With reference again to FIG. 2, in various exemplary embodiments, coalescing-enhancing-enhancing plate 108 comprises a corrosion resistant material. The material selected for coalescing-enhancing plate 108 may be dependent on the compositions of feed 102. For example, coalescing-enhancing plate 108 may comprise acrylonitrile butadiene styrene (ABS), nylon, polytetrafluoroethylene (PTFE), polyvinyl chloride (PVC), fiberglass reinforced plastic (FRP), or any suitable corrosion resistant plastic material. Coalescing-enhancing plate 108 may also comprise stainless steel, aluminum, titanium, or any suitable corrosion resistant metal. Any material which provides sufficient structural rigidity and durability to coalescing-enhancing plate 108 and is suitable for use with the components of feed 102 is in accordance with the present invention.

In various exemplary embodiments, coalescing-enhancing plate 108 can further comprise one or more structural reinforcing elements. For example, square tubing may be used on one or more edges of coalescing-enhancing plate 108 to provide structural support. Such structural reinforcing elements may comprise, for example, ABS, PVC, FRP, or any suitable corrosion resistant plastic material. In other embodiments, such structural reinforcing elements may comprise stainless steel, aluminum, titanium, or any suitable corrosion resistant metal. Any material which provides sufficient structural rigidity and reinforcement to coalescing-enhancing plate 108 and is suitable for use with the components of feed 102 is in accordance with the present invention.

With reference again to FIG. 2, in accordance with various exemplary embodiments, settler section 100 further comprises a primary phase weir 112 and a secondary phase weir 114. In various embodiments, primary phase weir 112 and secondary phase weir 114 are located in a discharge section 160.

In various exemplary embodiments, as feed 102 progresses through settler section 100, feed 102 is separated into two phases; a primary phase and a secondary phase. Each of the two phases is isolated in a corresponding weir. In various exemplary aspects, the primary phase is an organic phase. In various exemplary aspects, the secondary phase is an aqueous phase, which contains the metal values to be recovered in hydrometallurgical metal recovery process 10. However, the primary phase and the secondary phase may be any liquids which are inclined to separate from each other in settler section 100 in accordance with the present disclosure.

In an exemplary embodiment, primary phase weir 112 isolates the primary phase of feed 102. Primary phase weir 112 may comprise a well, adjustable weir, outlet pipe or pipes, extraction chute and/or collection channel. However, any physical structure which allows for the selective separation and removal of the primary phase from feed 102 is in accordance with the present disclosure. Although illustrated with a single primary phase weir 112, settler sections in accordance with the disclosure may include multiple primary phase weirs 112.

In an exemplary embodiment, secondary phase weir 114 isolates the secondary phase of feed 102. Secondary phase weir 114 may comprise a well, adjustable weir, outlet pipe or pipes, extraction chute and/or collection channel. However, any physical structure which allows for the selective separation and removal of the secondary phase from feed 102 is in accordance with the present disclosure. Although illustrated with a single secondary phase weir 114, settler sections in accordance with the disclosure may include multiple secondary phase weirs 114.

### Example

The following non-limiting example illustrates exemplary entrainment values obtained using a settler system in accordance with various embodiments of the invention. This example is merely illustrative, and it is not intended that the invention be limited to the example. Systems in accordance with the present invention may include the plate below as well as additional and/or alternative inert plates.

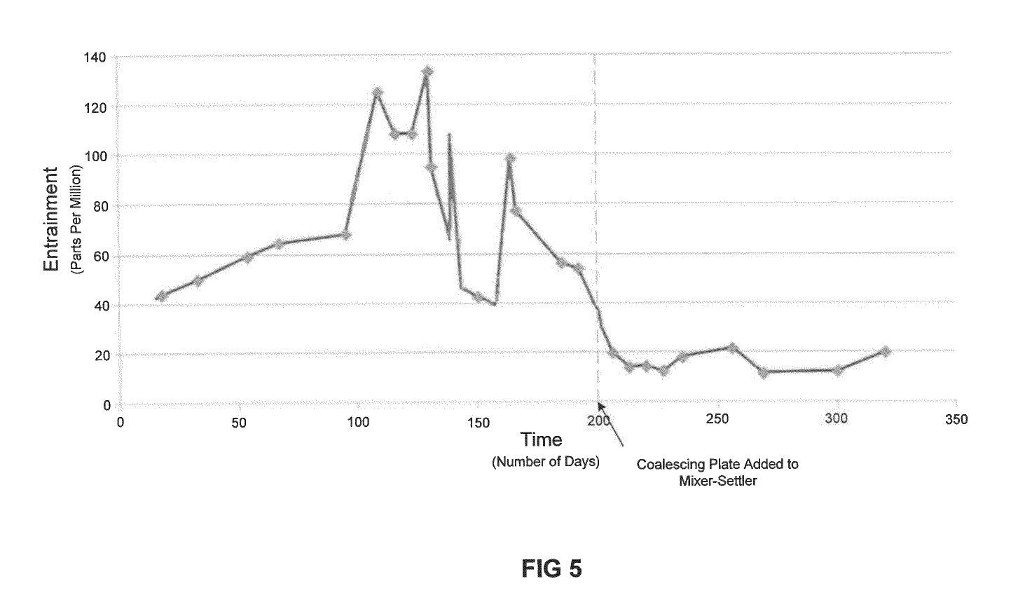

A mixer-settler was set up to monitor the entrainment of organic species in an aqueous phase in typical mixer-settlers using a coalescing-enhancing plate in accordance with the present disclosure. In the mixer-settler, a coalescing-enhancing plate was added near the discharge section, as the last internal structure prior to the weirs in the each cell. As each cell operated, the amount of organic phase entrained in the aqueous phase was recorded at regular intervals. The cell operated for a period of time before the coalescing-enhancing plate was added, and continued operating after the plate was added. The results of the testing are represented in FIG. 5.

After the coalescing-enhancing plate was added, the average organic entrainment in each mixer-settler decreased significantly. For example, during the period in which no coalescing-enhancing plate was used, the average organic entrainment in the aqueous phase was approximately 70 parts per million. After the coalescing-enhancing plate was installed, the average organic entrainment in the aqueous phase decreased to approximately 15 parts per million. In this particular application, organic entrainment was reduced approximately 80% by installing a coalescing-enhancing plate in accordance with the present disclosure.

Thus, the coalescing-enhancing plate of the present disclosure provides means to control the fluid flow of a dispersion as it progresses through an extraction circuit. The coalescing-enhancing plate beneficially increases coalescence in the mixer-settler, reducing entrainment in the phases of the dispersion.

Finally, the present disclosure has been described above with reference to a number of exemplary embodiments. It should be appreciated that the particular embodiments shown and described herein are illustrative of the invention and its best mode and are not intended to limit in any way the scope of the invention. Those skilled in the art having read this disclosure will recognize that changes and modifications may be made to the exemplary embodiments without departing from the scope of the present invention. Various aspects and embodiments of this invention may be applied to fields of use other than copper mining. Although certain preferred aspects of the invention are described herein in terms of exemplary embodiments, such aspects of the invention may be achieved through any number of suitable means now known or hereafter devised. Accordingly, these and other changes or modifications are intended to be included within the scope of the present invention.

What is claimed is:

1. A settling assembly comprising:
a vessel configured to conduct the flow of a mixture of two or more immiscible liquids comprising an inbound portion and an outbound portion, wherein a mixture enters the inbound portion and two or more separated phases of the mixture exit the outbound portion; and
a coalescing-enhancing plate comprising a front face and a rear face contained within the vessel, wherein the front face opposes the direction of the flow of the mixture and the rear face faces the direction of the flow of the mixture, and at least one group of openings, wherein the openings extend through the front face to the rear face and are configured to cause an increase in the phase separation of the mixture.

2. The mixer-settler assembly of claim 1, wherein the coalescing-enhancing plate is located near the outbound portion of the vessel.

3. The mixer-settler assembly of claim 1, wherein the coalescing-enhancing plate is substantially vertical relative to the bottom of the vessel.

4. The mixer-settler assembly of claim 1, wherein the front face of the coalescing-enhancing plate is substantially perpendicular to the flow of the mixture.

5. The mixer-settler assembly of claim 1, wherein the at least one group of openings is located along a substantially horizontal row.

6. The mixer-settler assembly of claim 5, further comprising a second group of openings located along a second substantially horizontal row.

7. The mixer-settler assembly of claim 15, further comprising a third group of openings located along a third substantially horizontal row.

8. The mixer-settler assembly of claim 1, wherein the coalescing-enhancing plate comprises a void section.

9. The mixer-settler assembly of claim 8, wherein the void section is located at or near the bottom of the coalescing-enhancing plate.

10. The mixer-settler assembly of claim 1, wherein the coalescing-enhancing plate comprises one or more of the materials selected from the group of polyvinyl chloride, fiberglass reinforced plastic, stainless steel, aluminum, and titanium.

11. The mixer-settler assembly of claim 1, further comprising a primary flow distributor.

12. The mixer-settler assembly of claim 11, further comprising at least one secondary flow distributor.

13. The mixer-settler assembly of claim 1, wherein the at least one group of openings is located at a position which corresponds to a position within a denser liquid of the mixture.

14. The mixer-settler assembly of claim 1, wherein the at least one group of openings is located at a position which corresponds to a position within a less dense liquid of the mixture.

15. A method for separating two liquids comprising:
introducing a mixture of two or more immiscible liquids into an inbound portion of a vessel comprising the inbound portion and an outbound portion, wherein the mixture comprises a first phase and a second phase;
partially separating the two or more immiscible liquids of the mixture; and
selectively manipulating the flux of the partially separated liquids of the mixture by passing the mixture through a coalescing-enhancing plate comprising a front face and a rear face contained within the vessel, wherein the front face opposes the direction of the flow of the mixture and the rear face faces the direction of the flow of the mixture, and at least one group of openings, wherein the openings extend through the front face to the rear face and are configured to cause an increase in the phase separation of the mixture.

16. The method of claim 15, wherein the coalescing-enhancing plate is located near the outbound portion of the vessel.

17. The method of claim 15, wherein the coalescing-enhancing plate is substantially perpendicular to the flow of the mixture.

18. The method of claim 15, wherein at least one of the liquids in the mixture comprises a metal value.

19. The method of claim 18, wherein the metal value is copper.

20. The method of claim 15, wherein the coalescing-enhancing plate comprises a second group of openings configured in a second substantially horizontal row.

21. The method of claim 20, wherein the coalescing-enhancing plate comprises a third group of openings configured in a third substantially horizontal row.

22. The method of claim 15, wherein the liquid comprises an aqueous phase and an organic phase.

23. The method of claim 15, wherein the at least one group of openings is located at a position which corresponds to a position within a denser liquid of the mixture.

24. The method of claim 15, wherein the at least one group of openings is located at a position which corresponds to a position within a less dense liquid of the mixture.

25. The method of claim 15, wherein the coalescing-enhancing plate comprises a void section.

26. The method of claim 25, wherein the void section is located at or near the bottom of the coalescing-enhancing plate.

27. A mixer-settler comprising the settling system of claim 1.
